(19) United States
(12) Patent Application Publication
(10) Pub. No.: US 2002/0075160 A1
(43) Pub. Date: Jun. 20, 2002

(54) Remotely controlled local interface lock -out system, with manual override, for electronic devices and appliances

(76) Inventors: Stephen Joseph Racz, Somerset, NJ (US); Robert Michael Groschadl, Bridgewater, NJ (US)

Correspondence Address: Stephen J. Racz, 4 Gunther Loop, Somerset, NJ, 08873, US

(21) Appl. No.: 09/945,875

(22) Filed: Sep. 5, 2001

Related U.S. Application Data
(60) Provisional application No. 60/230,910, filed on Sep. 13, 2000.

(51) Int. Cl. G08C 19/00

(52) U.S. Cl. 340/825.69; 340/5.74

(57) ABSTRACT

This invention is an improvement to existing and future electronic remote control devices and the device that is controlled. This added improvement or feature allows for an electronic remote control system to disable the local control (i.g. pushbuttons, touchpads, etc.) of any or all of the functions of an electronic device while still allowing these functions to be controlled remotely. The electronic devices include but are not limited to televisions, video cassette recorders (VCRs), digital video disc (DVD) players, stereos, radios, appliances or entry systems.

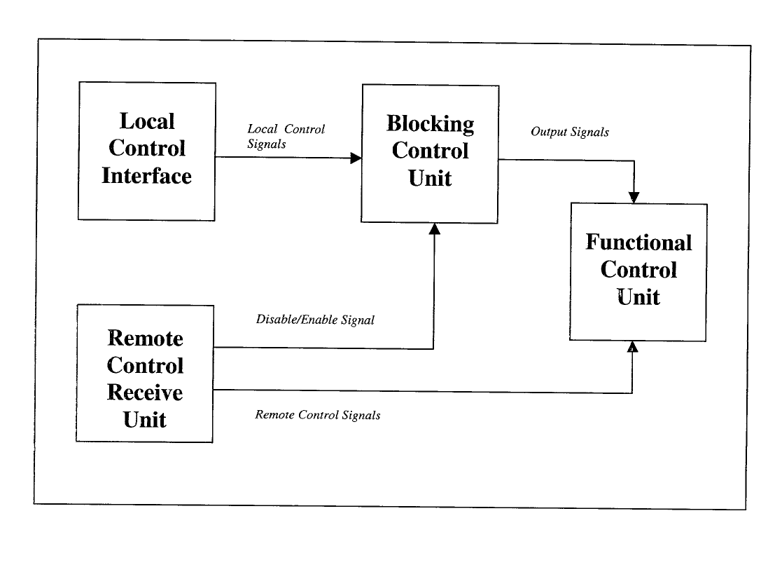

This disabling feature can be activated from, but not limited to, the remote control unit.

This disabling feature can be deactivated either via the local interface (i.g. pushbuttons, touchpads, etc.) on the device that is under control or remotely via the remote control. If done locally, the deactivation can be triggered by, but not limited to, a sequence the user executes via existing pushbuttons or by other means on the local interface. Local interface deactivation is needed in cases where the remote control unit becomes unusable for any reason while the said disabling feature is active.

### CROSS REFERENCE

Provisional Patent, application number 60/230,910, filed on Sep. 13, 2000. Title of invention is the same as above.

### BRIEF SUMMARY OF THE INVENTION

This invention is in the area of electronics. More specifically, it is applied as an improvement to remote control devices and the device that is controlled.

### BRIEF SUMMARY OF THE INVENTION

This invention in an improvement to electronic remote control systems, both present and future. The improvement is an additional feature that allows remote control systems to remotely disable the local control (i.g. pushbuttons, touchpads, etc.) of any or all of the functions of an electronic device, that is controls, while still allowing these functions to be controlled remotely. The electronic devices include but are not limited to televisions, video cassette recorders (VCRs), digital video disc (DVD) players, stereos, radios, appliances or entry systems.

This disabling feature can be activated from, but not limited to, the remote control unit.

This disabling feature can be deactivated either via the local interface (i.g. pushbuttons, touchpads, etc.) on the device that is under control or remotely via the remote control. If done locally, the deactivation can be triggered by, but not limited to, a sequence the user executes via existing pushbuttons or by other means on the local interface. Local interface deactivation is needed in cases where the remote control unit becomes unusable for any reason while the said disabling feature is active.

### BRIEF DESCRIPTION OF THE VIEW OF THE DRAWING

The functional block diagram of the design concept and implementation shown on the page titled “Drawing:” of this Utility Patent Application describes a system that remotely disables the local control of any or all of the functions of an electronic device while still allowing theses functions to be controlled remotely. The electronic devices include but are not limited to televisions, video cassette recorders (VCRs), digital video disc (DVD) players, stereos, radios, appliances or entry systems. This disabling feature can be deactivated either locally or remotely. In the following section titled “Detailed Description of the Invention”, blocks are denoted in boldface and signals are denoted in Italics.

### DETAILED DESCRIPTION OF THE INVENTION

This section describes an improvement to existing and future electronic remote control devices and the device that is controlled. The functional block diagram of the design concept and implementation shown on the page titled “Drawing:” of this Utility Patent Application describes a system that remotely disables the local control of any or all of the functions of an electronic device while still allowing these functions to be controlled remotely. The electronic devices include but are not limited to televisions, video cassette recorders (VCRs), digital video disc (DVD) players, stereos, radios, appliances or entry systems. This disabling feature can be deactivated either locally or remotely. Blocks are denoted in boldface. Signals are denoted in Italics.

The Local Control Interface is the physical means by which the user controls the functions of the electronic device. This is done via pushbuttons, keypads, touchpads, or any type of mechanical switch. The outputs of the Local Control Interface are the Local Control Signals that electronically control the functions of the device.

The Remote Control Receive Unit is located inside the electronic device. It decodes the signal from a remote control device into signals that are useable by the Functional Control Unit and Blocking Control Unit.

What is claimed is:

1. An improvement to existing and future electronic remote control devices and the device that is controlled by providing a means to temporarily disable the local interface (or any part of) of the device under control.

2. A method according to claim 1, wherein this added improvement or feature allows for an electronic remote control system to disable the local control (i.g. pushbuttons, touchpads, etc.) of any or all of the functions of an electronic device while still allowing these functions to be controlled remotely.

3. A method according to claim 1, wherein the electronic devices include but are not limited to televisions, video cassette recorders (VCRs), digital video disc (DVD) players, stereos, radios, appliances or entry systems.

4. A method according to claim 1, further comprising that the disabling feature can be activated from, but not limited to, the remote control unit.

5. A method according to claim 1, wherein the disable feature can be deactivated either remotely via the remote control or via the local interface (i.g. pushbuttons, touchpads, etc.) on the device that is under control.

6. A method according to claim 5, wherein deactivation via the local interface can be triggered by, but not limited to, a sequence the user executes via existing pushbuttons or by other means on the local interface.

7. A method according to claim 5, further comprising local interface deactivation is needed in cases where the remote control unit becomes unusable for any reason while the said disable feature is active.
